(19) United States
(12) Patent Application Publication
(10) Pub. No.: US 2019/0389695 A1
(43) Pub. Date: Dec. 26, 2019

(54) ELEVATOR SYSTEM

(71) Applicant: Otis Elevator Company, Farmington, CT (US)

(72) Inventors: Andrés Monzon, Leganes (ES); Mario Sanz Abia, Valladolid (ES); Ruben Marante-Chasco, Madrid (ES); Fernando Del Rio, Torrelodones (ES)

(21) Appl. No.: 16/440,351

(22) Filed: Jun. 13, 2019

(30) Foreign Application Priority Data
Jun. 22, 2018 (EP) 18179335.7

(51) Int. Cl. B66B 5/16; B66B 5/00; B66B 5/04; B66B 11/02

(52) U.S. Cl. CPC B66B 5/16; B66B 5/0031; B66B 11/0226; B66B 5/0087; B66B 5/04

(57) ABSTRACT

An elevator system (2) comprises a hoistway (4) extending between a plurality of landings (8a, 8b, 8c); an elevator car (60) configured for moving in two opposite directions along the hoistway (4); and an elevator safety system. The elevator safety system comprises a bidirectional safety gear (20) configured for stopping, upon activation, any movement of the elevator car (60) traveling in any of the two opposite directions; and a safety controller (30) configured for activating the bidirectional safety gear (20) when a predefined safety condition is met. The safety controller (30) is switchable between a plurality of different safety modes, each safety mode setting at least one predefined safety condition.

### FOREIGN PRIORITY

This application claims priority to European Patent Application No. 18179335.7, filed Jun. 22, 2018, and all the benefits accruing therefrom under 35 U.S.C. §119, the contents of which in its entirety are herein incorporated by reference.

### BACKGROUND

The invention relates to an elevator system comprising an elevator safety system.

An elevator system typically comprises at least one elevator car moving along a hoistway between a plurality of landings, and a driving member configured for driving the elevator car.

An elevator system usually further comprises an elevator safety system configured for monitoring and checking the operation of the elevator system in order to stop any further operation of the elevator system, in particular any movement of the elevator car, in case an unsafe condition of the elevator system is detected. Unsafe conditions of the elevator system in particular may include situations in which a person, such as a mechanic, enters the hoistway for maintaining and/or repairing the elevator system.

It would be beneficial to provide an elevator system with a reliable elevator safety system ensuring the safety of persons, in particular mechanics, being present within the hoistway above or below the elevator car without restricting the maintenance and repair of the elevator system more than necessary. It further would be beneficial if such an elevator safety system could be operated easily and conveniently.

### BRIEF DESCRIPTION

According to an exemplary embodiment of the invention, an elevator system comprises a hoistway extending between a plurality of landings, an elevator car configured for moving in two opposite directions along the hoistway, and an elevator safety system. The elevator safety system comprises a bidirectional safety gear configured for stopping, upon activation, any movement of the elevator car in any of the two directions, and a safety controller configured for activating the bidirectional safety gear when a predefined safety condition is met. The safety controller is switchable between a plurality of different safety modes, each safety mode setting at least one predefined safety condition.

Exemplary embodiments of the invention also include a method of operating an elevator system according to an exemplary embodiment of the invention, the method including switching the safety controller to one of the plurality of different safety modes.

An elevator system and a method according to exemplary embodiments of the invention ensure the safety of persons, in particular mechanics, working within the hoistway. Allowing a mechanic to select between a plurality of different safety modes allows reducing the operational restrictions imposed by the safety system in order to impede the maintenance and repair of the elevator system as little as possible.

A number of optional features are set out in the following. These features may be realized in particular embodiments, alone or in combination with any of the other features, unless explicitly stated otherwise.

The elevator system may comprise a car position sensor configured for detecting the absolute position of the elevator car within the hoistway. The plurality of safety modes may comprise at least one safety mode in which at least one predefined upper positional limit and/or at least one predefined lower positional limit are set, and the safety controller may be configured activating the bidirectional safety gear when the absolute position of the elevator car exceeds the predefined upper positional limit and/or when the absolute position of the elevator car falls below the predefined lower positional limit. Such a configuration allows ensuring the safety of mechanics working within the hoistway above or below the elevator car.

The car position sensor may be part of an absolute position reference system including the car position sensor and a coded tape, in particular a mechanically, optically and/or magnetically coded tape, extending along the height of the hoistway. Such an absolute position reference system allows for a reliable and exact determination of the position of the elevator car within the hoistway.

The plurality of safety modes may comprise at least one “below the car inspection mode” in which only a lower positional limit to the movement of the elevator car is set for ensuring the safety of a mechanic working below the elevator car, in particular in a pit formed at the bottom of the hoistway.

The plurality of safety modes may comprise at least one “top of car inspection mode” in which only an upper positional limit to the movement of the elevator car is set for ensuring the safety of a mechanic working above the elevator car, in particular on the roof of the elevator car.

The plurality of safety modes may also comprise at least one safety mode in which both, an upper positional limit and a lower positional limit are set so that the elevator car is allowed to move only within a range defined by the upper and lower positional limits.

In at least one of the plurality of safety modes, the safety controller may be configured for determining the moving speed of the elevator car and activating the bidirectional safety gear when the determined moving speed of the elevator car exceeds a predetermined limit of the moving speed (moving speed limit). The predetermined moving speed limit may be set as a function of the currently selected safety mode and/or as a function of the current position of the elevator car within the hoistway.

The plurality of safety modes in particular may include at least one maintenance mode in which the moving speed of the elevator car is reduced compared to the moving speed of the elevator car during normal (non-maintenance) operation of the elevator system.

Reducing and monitoring the moving speed of the elevator car allows moving the elevator car along the hoistway for maintenance purposes while still ensuring the safety of a mechanic being present within the hoistway, in particular above or below the elevator car.

The safety controller may be configured for determining the moving speed of the elevator car from the change of the absolute position of the elevator car detected by the car position sensor.

The elevator system may also comprise a speed sensor configured for detecting the moving speed of the elevator car moving along the hoistway.

In order to enhance the safety of the elevator system even further, the safety controller may be configured for determining the moving speed of the elevator car from the change of the absolute position of the elevator car detected by the car position sensor and for comparing the achieved result with a speed signal provided by a speed sensor.

The bidirectional safety gear may include at least one bidirectionally acting safety mechanism, i.e. a safety mechanism which is configured for braking the movement of the elevator car when moving in any of the two opposite directions (upwards and downwards).

Alternatively, the bidirectional safety gear may include a combination of at least two unidirectionally acting safety mechanisms, with each safety mechanism being configured for braking the movement of the elevator car when moving in one direction, respectively. In order words, the bidirectional safety gear may comprise a first safety mechanism configured for braking an upward movement of the elevator car, and a second safety mechanism configured for braking a downward movement of the elevator car. The two safety mechanisms may be integrated with each other, or they may be provided separately from each other.

Conventional safety mechanisms may be used as unidirectional safety mechanisms. This may reduce the costs of the elevator safety system. On the other hand, a bidirectional safety mechanism may be designed so that it needs less space than a combination of two unidirectional safety mechanisms.

The bidirectional safety gear may include at least one bidirectional safety actuator, i.e. a safety actuator which is configured for actuating at least two engagement members comprising at least one first engagement member configured for braking an upward movement of the elevator car, and at least one second engagement member configured for braking a downward movement of the elevator car.

Alternatively, the bidirectional safety gear may include a combination of at least two unidirectional safety actuators, wherein each safety actuator is configured for actuating at least one engagement member configured for braking the movement of the elevator car in one direction, respectively. In other words, the bidirectional safety gear may include a first safety actuator configured for actuating at least one engagement member configured for braking an upward movement of the elevator car, and a second safety actuator configured for actuating at least one engagement member configured for braking a downward movement of the elevator car.

Conventional safety actuators may be used as unidirectional safety actuators. This may reduce the costs of the elevator safety system. On the other hand, a bidirectional safety actuator may be designed so that it needs less space than a combination of two unidirectional safety actuators.

The plurality of safety modes may include at least one safety mode in which the bidirectional safety gear is activated only after the movement of the elevator car has been stopped. Activating the bidirectional safety gear only after the movement of the elevator car has been stopped reduces the wear of the bidirectional safety gear and the wear of the guide members of the elevator system.

The plurality of safety modes may include at least one safety mode in which the bidirectional safety gear is activated while the elevator car is still moving. Activating the bidirectional safety gear while the elevator car is still moving results in a very fast and effective braking of the movement of the elevator car. Such a fast braking (emergency braking) is beneficial in particular in emergency situations in order to avoid severe accidents, such as a mechanic being hit or squeezed by the moving elevator car.

In order to allow for a convenient maintenance and/or repair of the elevator system, the plurality of safety modes may include at least one safety mode in which the elevator car is moved to a predetermined position with respect to a landing, in particular with respect to a sill or a lintel of a landing door, in order to allow a mechanic to easily access components of the elevator system installed within the hoistway next to the respective landing/landing door.

### DRAWING DESCRIPTION

In the following, exemplary embodiments of the invention are described in more detail with respect to the enclosed figures:

FIG. 1 schematically depicts an elevator system according to an exemplary embodiment of the invention.

FIG. 2 depicts a schematic perspective view of an elevator car according to an exemplary embodiment of the invention.

FIG. 3 schematically depicts a first exemplary embodiment of a bidirectional elevator safety gear.

FIG. 4 schematically depicts a second exemplary embodiment of a bidirectional elevator safety gear.

FIG. 5 schematically depicts a third exemplary embodiment of a bidirectional elevator safety gear.

FIG. 6 schematically depicts a fourth exemplary embodiment of a bidirectional elevator safety gear.

FIG. 7 depicts a schematic perspective view of an elevator car comprising a remote control installed on the roof of the elevator car.

FIG. 8 depicts a control panel of a remote control according to an exemplary embodiment.

FIG. 9 depicts a control panel of a remote control according to another exemplary embodiment.

### DETAILED DESCRIPTION

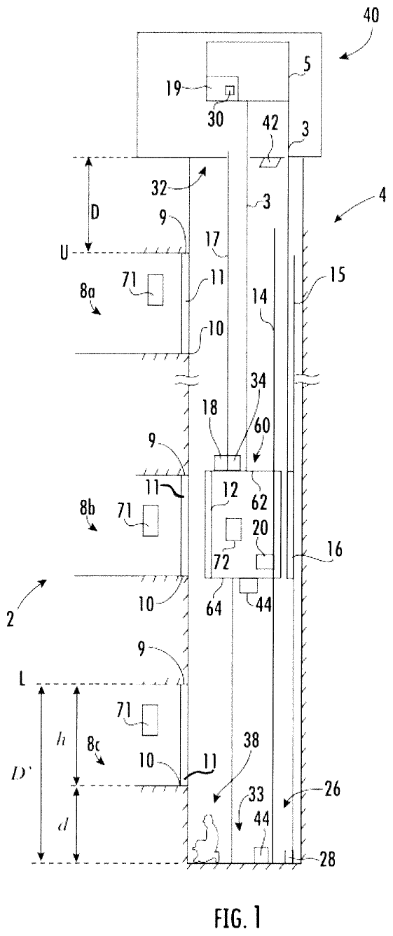

FIG. 1 schematically depicts an elevator system 2 according to an exemplary embodiment of the invention.

The elevator system 2 includes an elevator car 60 movably arranged within a hoistway 4 extending between a plurality of landings 8a, 8b, 8c. The elevator car 60 in particular is movable along at least one car guide member 14 (guide rail), extending along the vertical direction of the hoistway 4. Although only one elevator car 60 is depicted in FIG. 1, the skilled person will understand that exemplary embodiments of the invention may include elevator systems 2 having a plurality of elevator cars 60 moving in one or more hoistways 4.

The elevator car 60 is movably suspended by means of a tension member 3. The tension member 3, for example a rope or belt, is connected to an elevator drive 5, which is configured for driving the tension member 3 in order to move the elevator car 60 along the height of the hoistway 4 between the plurality of landings 8a, 8b, 8c, which are located on different floors.

Each landing 8a, 8b, 8c is provided with a landing door 11, and the elevator car 60 is provided with a corresponding elevator car door 12 for allowing passengers to transfer between a landing 8a, 8b, 8c and the interior of the elevator car 60 when the elevator car 60 is positioned at the respective landing 8a, 8b, 8c.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The elevator system 2 includes further a counterweight 16 attached to the tension member 3 opposite to the elevator car 60 and moving concurrently and in opposite direction with respect to the elevator car 6 along at least one counterweight guide member 15. At least one buffer 28 may be provided within a pit 26 formed at a lower end 33 of the hoistway 4.

The skilled person will understand that the invention may be applied to elevator systems 2 which do not comprise a counterweight 16 as well.

The tension member 3 may be a rope, e.g. a steel wire rope, or a belt, e.g. a coated steel belt. The tension member 3 may be uncoated. Alternatively, the tension member may have a coating, e.g. in the form of a polymer jacket. In a particular embodiment, the tension member 3 may be a belt comprising a plurality of polymer coated steel cords (not shown). The elevator system 2 may have a traction elevator drive including a traction sheave for driving the tension member 3. In an alternative configuration, which is not shown in the figures, the elevator system 2 may be an elevator system 2 without a tension member 3, comprising e.g. a hydraulic elevator drive, friction wheels, or a linear elevator drive. The elevator drive 5 may be installed in a machine room 40 provided next to an upper end 32 of the hoistway 4. Alternatively, the elevator system 2 may be a machine room-less elevator system 2, e.g. an elevator system 2 in which the elevator drive 5 is located within the hoistway 4. The elevator drive 5 also may be accommodated in a cabinet (not shown) provided in the surroundings of the hoistway 4. The cabinet, for example may be attached to or enclosed in a landing door 11.

The elevator drive 5 is controlled by an elevator controller 19 for moving the elevator car 60 along the hoistway 4 between the different landings 8a, 8b, 8c.

Input to the elevator controller 19 may be provided via landing control panels 71 provided on each of the landings 8a, 8b, 8c, in particular close to the landing doors 11, and/or via an elevator car control panel 72 provided inside the elevator car 60.

The elevator system 2 comprises at least one car position sensor 18 configured for determining the position of the elevator car 60 within the hoistway 4. The car position sensor 18 may be part of an absolute position reference system 17, 18 including the car position sensor 18 and a coded tape 17 extending along the length (height) of the hoistway 4. In such a configuration, the car position sensor 18 is configured for interacting with the code tape 27 for determining the current position of the elevator car 6 within the hoistway 4. The coded tape 17 may be coded mechanically, optically, and/or magnetically.

The elevator system 2 further may be provided with a speed sensor 34 configured for detecting the moving speed of the elevator car 60 when moving along the hoistway 4. The speed sensor 34 may be attached to the elevator car 60. The speed sensor 34 may be formed integrally with, or separately from, the car position sensor 18. The speed sensor 34 in particular may be configured to use the position information provided by the car position sensor 18 for determining the moving speed of the elevator car 60.

Additionally or alternatively, a speed sensor (not shown) may be provided at the elevator drive 5 for determining the moving speed of the elevator car 60 by detecting the moving speed of the tension member 3 at the elevator drive 5, e.g. by detecting the rotational speed of an axle or sheave driving the tension member 3.

The landing control panels 71, the elevator car control panel 72, the car position sensor 18 and the speed sensor 34 may be connected with the elevator controller 19 by electrical wires (not shown in FIG. 1), in particular by an electric bus. Alternatively or additionally, wireless data connections may be used for transmitting information from the control panels 71, 72 and/or the sensors 18, 34 to the elevator controller 19.

Further components 42, 44 of the elevator system 2 may be installed at the upper and lower ends 32, 33 of the hoistway 4.

At least one of the elevator car 60 and the counterweight 16 is equipped with at least one safety gear 20.

In the exemplary embodiment depicted in FIG. 1, a safety gear 20 is attached to the elevator car 60. Alternatively or additionally, at least one safety gear 20 may be attached to the counterweight 16. A safety gear 20 attached to the counterweight 16, however, is not depicted in FIG. 1.

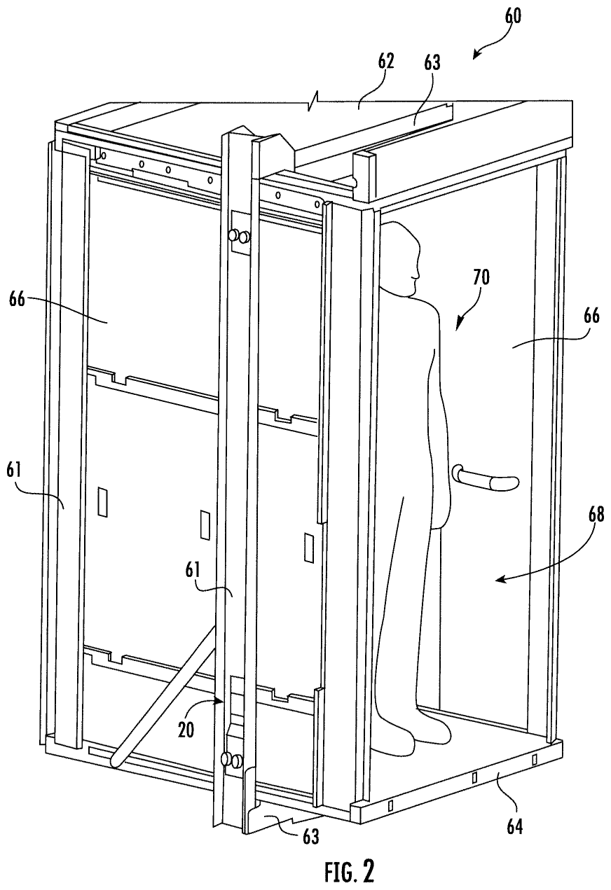

FIG. 2 is an enlarged perspective view of an elevator car 60 according to an exemplary embodiment of the invention. The elevator car 60 comprises a structural frame comprising vertically extending uprights 61 and crossbars 63 extending horizontally between the uprights 61.

The elevator car 60 further includes a roof 62, a floor 64 and a plurality of side walls 66. In combination, the roof 62, the floor 64 and the plurality of side walls 66 define an interior space 68 for accommodating and carrying passengers 70 and/or cargo (not shown).

A safety gear 20 is attached to an upright 61 of the elevator car 60.

Although only one safety gear 20 is depicted in FIGS. 1 and 2, respectively, the skilled person will understand that a plurality of safety gears 20 may be mounted to a single elevator car 60. In particular, in a configuration in which the elevator system 2 comprises a plurality of car guide members 14, a safety gear 20 may be associated with each car guide member 14.

Alternatively or additionally, two or more safety gears 20 may be provided on top of each other at the same upright 61 of the elevator car 60 in order to engage with the same car guide member 14.

The safety gear 20 is operable to brake or at least assist in braking (i.e. slowing or stopping the movement) of the elevator car 60 relative to a car guide member 14 by engaging with the car guide member 14. In the following, the structure and the operating principle of a safety gear 20 according to an exemplary embodiment of the invention will be described.

According to exemplary embodiments of the invention, the safety gear 20 is a bidirectional safety gear 20, i.e. a safety gear 20 which allows braking the movement of the elevator 60 in both directions, i.e. no matter whether the elevator car 60 is moving upwards or downwards.

Four exemplary embodiments of such bidirectional safety gears 20 are schematically depicted in FIGS. 3 to 6.

FIG. 3 shows a first exemplary embodiment of a bidirectional safety gear 20 comprising two engagement mechanisms 22a, 22b. Each engagement mechanism 22a, 22b comprises two engagement elements 23a, 23b configured for engaging with a guide member 14, 15 for braking the movement of the elevator car 60 in one direction, respectively. The bidirectional safety gear 20 further comprises a (single) actuator 24 configured for actuating the two engagement mechanism 22a, 22b.

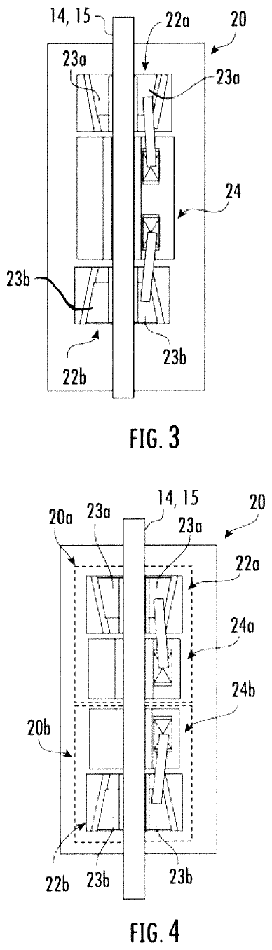

FIG. 4 shows a second exemplary embodiment of a bidirectional safety gear 20. The bidirectional safety gear 20 according to the second embodiment also comprises two engagement mechanisms 22a, 22b. Each engagement mechanism 22a, 22b comprises two engagement elements 23a, 23b configured for engaging with a guide member 14, 15 for braking the movement of the elevator car 60 in one direction, respectively.

The bidirectional safety gear 20 according to the second embodiment further comprises two actuators 24a, 24b. Each of the two actuators 24a, 24b is configured for actuating one of the two engagement mechanisms 22a, 22b, respectively.

Thus, a bidirectional safety gear 20 according to the second embodiment includes a combination of two unidirectional elevator safety mechanisms 20a, 20b, each of the unidirectional elevator safety mechanisms 20a, 20b comprising an engagement mechanism 22a, 22b and an actuator 24a, 24b, respectively.

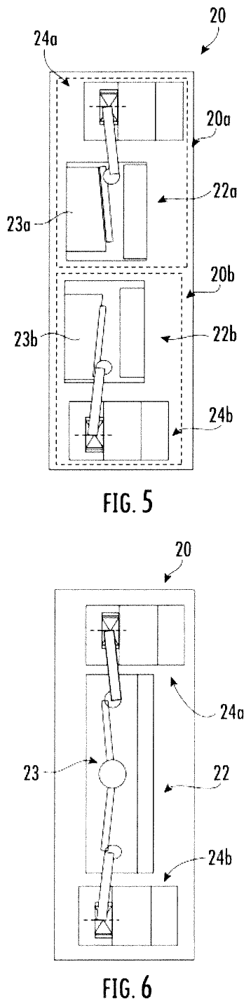

FIG. 5 shows a third exemplary embodiment of a bidirectional safety gear 20. The bidirectional safety gear 20 according to the third embodiment also comprises two unidirectional elevator safety mechanisms 20a, 20b. Each unidirectional elevator safety mechanism 20a, 20b comprises a roller type engagement mechanism 22a, 22b including an engagement element 23a, 23b configured for engaging with a guide member (not depicted in FIG. 5) in order to brake the movement of the elevator car 60 in one direction, and an actuator 24a, 24b configured for actuating the respective engagement mechanism 22a, 22b.

FIG. 6 shows a fourth exemplary embodiment of a bidirectional safety gear 20. The bidirectional safety gear 20 comprises a bidirectional roller type engagement mechanism 22 configured for engaging with a guide member (not depicted in FIG. 6) in order to brake the movement of the elevator car 60 in both directions. The bidirectional safety gear 20 comprises two actuators 24a, 24b. Each actuator 24a, 24b is configured for actuating the bidirectional roller type engagement mechanism 22 for braking the movement of the elevator car 60 in one direction, respectively. In other words, a first actuator 24a is configured for actuating the bidirectional roller type engagement mechanism 22 for braking the movement of the elevator car 60 in a first direction, and a second actuator 24b is configured for actuating the bidirectional roller type engagement mechanism 22 for braking the movement of the elevator car 60 in a second direction opposite to the first direction.

The skilled person understands that the exemplary embodiments of bidirectional elevator safety gears 20 depicted in FIGS. 3 to 6 are only exemplary and not exclusive, and that other types of bidirectional elevator safety gears 20 not shown in the figures may be employed in elevator systems 2 according to embodiments of the invention as well.

In an elevator system 2 according to an exemplary embodiment of the invention, a safety controller 30 is configured for activating the at least one bidirectional safety gear 20 when a predefined safety condition met, in particular when the position of the elevator car 60 as determined by the car position sensor 18 exceeds a predetermined upper positional limit U and/or falls below a predetermined lower positional limit L (see FIG. 1).

The safety controller 30 may be integrated with or provided separately from the elevator controller 19.

The safety controller 30 is switchable between a plurality of different safety modes. Each safety mode may set an upper positional limit U and/or a lower positional limit L associated with the respective safety mode.

Optionally, in at least some of the safety modes, a limit for the moving speed of the elevator car 60 (moving speed limit) may be set in addition to the positional limits U, L. In such a configuration, the at least one bidirectional safety gear 20 is activated when the moving speed of the elevator car 60 exceeds the moving speed limit set in the currently active safety mode of the safety controller 30.

The moving speed limit may depend on the current position of the elevator car 60 within the hoistway 4. In particular, the allowed maximum moving speed of the elevator car 60 defined by the moving speed limit may be lower when the elevator car 60 approaches one of the upper and lower ends 32, 33 of the hoistway 4 than when the elevator car 60 is located in a central portion of the hoistway 4, i.e. in some distance from the upper and lower ends 32, 33 of the hoistway 4.

Activating the at least one bidirectional safety gear 20 may include “releasing” the engagement member(s) 23, 23a, 23b and/or “tripping” the engagement member(s) 23, 23a, 23b.

In the context of the present invention, “releasing” the engagement members 23, 23a, 23b refers to moving the engagement members 23, 23a, 23b in contact with the guide member 14, 15 after the movement of the elevator car 60 has been stopped by other means, in particular by the elevator drive 5.

The engagement members 23, 23a, 23b are wedge-shaped, and thus, they are self-engaging, i.e., an engagement member 23, 23a, 23b touching the guide member 14, 15 engages with the guide member 14, 15 when it is moved with respect to the guide member 14, 15 due to a movement of the elevator car 60 along the guide member 14, 15. In other words, a “released” engagement member 23, 23a, 23b touches the guide member 14, 15 but does not (yet) engage with the guide member 14, 15. In case of an unscheduled movement of the elevator car 60, “released” engagement members 23, 23a, 23b engage with the guide rail 14, 15 due to their self-engaging functionality, thereby stopping any further movement of the elevator car 60. In consequence, “released” engagement members 23, 23a, 23b provide additional safety against an unscheduled new movement of the elevator car 60 after the elevator car 60 has been stopped before.

In contrast, “tripping” the engagement members 23, 23a, 23b refers to moving the engagement members 23, 23a, 23b in contact with the guide member 14, 15 in a situation in which the elevator car 60 is still moving. In this case, the engagement members 23, 23a, 23b instantaneously engage with the guide member 14, 15 braking the elevator car 60 and stopping the movement of the elevator car 60 almost immediately.

A predefined “tripping speed” defines an upper limit to the moving speed of the elevator car 60. Thus, the engagement members 23, 23a, 23b are tripped when the actual moving speed of the elevator car 60 exceeds the predefined tripping speed.

In contrast to “releasing” the engagement members 23, 23a, 23b, “tripping” the engagement members 23, 23a, 23b may cause substantial wear or even damage to the guide members 14, 15 and/or to the engagement members 23, 23a, 23b. Thus, “releasing” the engagement members 23, 23a, 23b is the preferred mode of operation, and the engagement members 23, 23a, 23b should be “tripped” only if necessary for braking the elevator car 60 in an emergency situation.

The safety modes may comprise at least one top of car access and inspection mode designated to be activated for accessing components 42 of the elevator system 2 located on top of the elevator car 60, in particular in the roof 62 of the elevator car 60 and/or at the upper end 32 of the hoistway 4.

The at least one top of car access and inspection mode in particular may include one or more of the following modes:

A “top of car default mode”, in which the elevator car 60 is stopped and the engagement members 23, 23a, 23b are released but not tripped. Once said top of car default mode is established, the tripping speed is decreased, in order to reduce the likelihood of damaging or wearing out the guide rails 14, 15 and the engagement members 23, 23a, 23b of the safety gear 20. It further reduces shock loads acting on the structure of the elevator car 60.

This mode is usually active, when one of the landing doors 11 except for the landing door 11 at the lowermost landing 8c has been opened in normal (non-maintenance) operation. A detection element may be provided in an unlocking device of the landing door 11 in addition to a mandatory switch linked to the door lock. The elevator system 2 is usually operated in the “top of car default mode” right before a mechanic 38 (see FIG. 1) intending to climb onto the roof 62 of the elevator 60 establishes a maintenance mode.

A “top of car access mode”. The “top of car access mode” may be activated by sending a certain signal, for example via a smart wireless device, to the safety controller 30. Upon receipt of said signal, the elevator car 60 is moved to and stopped at a desired landing 8a, 8b, 8c in particular in a position allowing easy access to the roof 62 of elevator car 60. In order to ensure safety, the at least one bidirectional safety gear 20 is activated releasing the engagement members 23, 23a, 23b after the movement of the elevator car 60 has been stopped.

In a “normal inspection mode” mode, the elevator car 60 may move between a lower positional limit L and an upper positional limit U (see FIG. 1) corresponding to different heights of the elevator car 60 within the hoistway 4. The elevator car 60, however, is not allowed to move into restricted areas next to the upper and lower ends 32, 33 of the hoistway 4.

The top (roof 62) of the elevator car 60 in particular has to stay in a predefined minimum distance D from the upper end 32 (ceiling) of the hoistway 4 for providing a space of refuge above the elevator car 60. When the position sensor 18 is arranged on top of the elevator car 60, as in the embodiment depicted in FIG. 1, the upper positional limit U, for example, may correspond basically with the height of a lintel 9 of the landing door 11 of the uppermost landing 8a. The tripping speed of the engagement members 23, 23a, 23b may be decreased when the safety controller 30 is operated in the “normal inspection mode”.

Similarly, the bottom (floor 64) of the elevator car 60 has to stay in a predefined minimum distance (height) d from the lower end 33 of the hoistway 4 for providing a space of refuge below the elevator car 60. When the position sensor 18 is arranged on top of the elevator car 60, the height h of the elevator car 60 needs to be taken into account when setting the lower positional limit L. Thus, the lower positional limit L for the position of the position sensor 18 needs to be set to a distance D′=d+h from the bottom 33 of the lower end 33 of the hoistway 4, e.g. to a position basically corresponding with the height of the lintel 9 of the landing door 11 at the lowermost landing 8c.

The skilled person understands that the upper and lower positional limits U, L need to be set differently when the position sensor 18 is arranged below the elevator car 60 or at a vertical position in between the roof 62 and the floor 64 of the elevator car 60.

In a “long hoistway mode”, the inspection speed is increased when at least one inspection mode button (not shown) is pressed for a predetermined time period, e.g. for a plurality of seconds. This allows moving the elevator car 60 over some distance along a comparatively long hoistway 4 in a short period of time.

In a “top landing door inspection mode”, the elevator car 60 is allowed to reach a position in which the lintel 9 of the landing door 11 at the uppermost landing 8a can be inspected and repaired conveniently. In the “top landing door inspection mode”, the inspection speed, i.e. the moving speed of the elevator car 60, is decreased, and the engagement elements 23, 23a, 23b are released every time the elevator car 60 has been stopped.

In a “bottom landing door inspection mode”, the elevator car 60 is allowed to reach a position in which the lintel 9 of the landing door 11 at the lowermost landing 8c can be inspected and repaired conveniently. In the “bottom landing door inspection mode”, the inspection speed, i.e. the moving speed of the elevator car 60, is decreased, and the engagement elements 23, 23a, 23b are released every time the elevator car 60 has been stopped.

In a “top of hoistway inspection mode”, the elevator car 60 may reach a position in which components 42 of the elevator system 2 installed at the upper end 32 of the hoistway 4 can be inspected and repaired conveniently. In the “top of hoistway inspection mode”, the inspection speed is decreased, and the engagement elements 23, 23a, 23b are released every time the elevator car 60 has been stopped.

The plurality of safety modes may further include pit access and inspection modes designated to be activated for accessing components 44 (see FIG. 1) of the elevator system 2 located below the elevator car 60, in particular within the pit 26 formed at the lower end 33 of the hoistway 4.

The pit access and inspection modes in particular may include one or more of the following modes:

A “pit access and inspection default mode”, in which the elevator car 60 is stopped and is not allowed to reach any level below the sill 10 of the landing door 11 at the lowermost landing 8c. This mode is activated when a landing door 11 providing access to the pit 26 is opened while the elevator system 2 is operated in a normal operation (non-maintenance) mode. In addition to a mandatory switch linked to the door lock, a detection element may be provided in a door unlocking device of the landing door 11. The “pit access and inspection default mode” is the status of the system right before a mechanic 30 activates a maintenance mode for entering into the pit 26.

A “pit work mode”, in which the elevator car 60 and the counterweight 16 are sent to positions allowing components 44 located in the pit 26 to be inspected and/or repaired. In the “pit work mode”, the engagement elements 23, 23a, 23b are released as soon as the elevator car 60 has been stopped.

A “counterweight inspection mode”, in which the elevator car 60 is moved to the upper end 33 of the hoistway 4 until the counterweight 16 rests on the at least one buffer 28 provided within the pit 26. The engagement elements 23, 23a, 23b are released as soon as the elevator car 60 and the counterweight 16 have been stopped in said configuration.

A “bottom of car inspection mode”, in which the elevator car 60 is allowed to move with a reduced moving speed while a mechanic 38 is present with the pit 26. The elevator car 60 is stopped by tripping the engagement elements 23, 23a, 23b allowing the mechanic 30 to inspect and/or repair the floor 64 and/or components 44 mounted to the bottom of the elevator car 60.

The safety controller 30 may be switched between the different modes using a remote control 36. A remote control 36 may be provided at and/or within the elevator car 60, within the hoistway 4, at an entrance to the hoistway 4 and/or in the machine room 40 of the elevator system 2. The remote control 36 also may be a mobile remote control carried by the mechanic 38. In order to allow transmitting commands from the remote control 36 to the safety controller 30, the remote control 36 may be connected with the safety controller 30 by electrical wires (not shown), or by a wireless data connection.

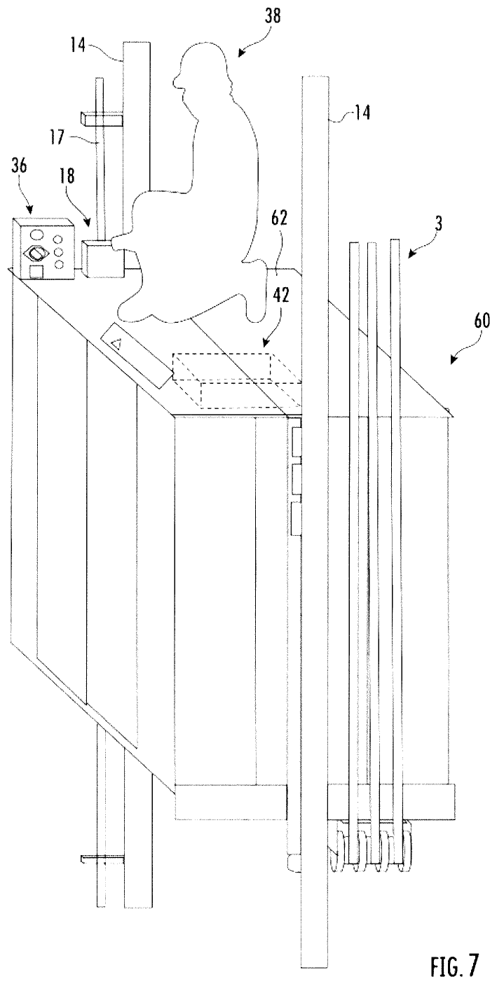

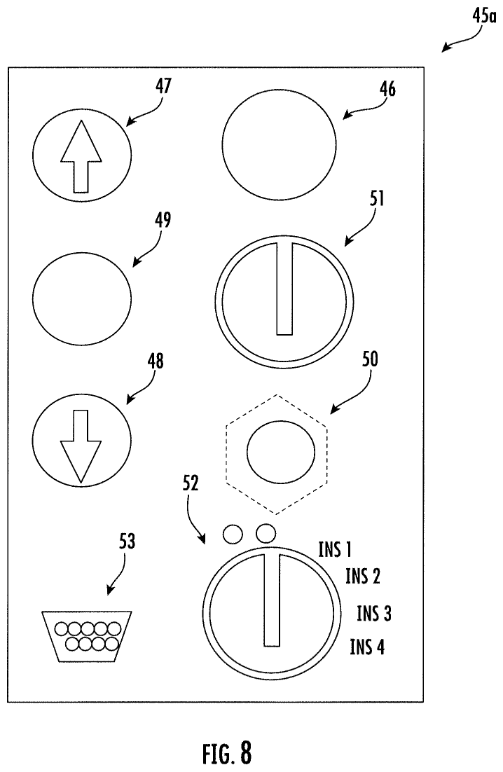

FIG. 7 shows a schematic perspective view of an elevator car 60 comprising a remote control 36 provided on the roof 62 of the elevator car 60. The remote control 36 may be integrated into a car inspection box, in particular a “PRESSRAL” car inspection box, provided on the roof 62 of the elevator car 60.

Such a configuration allows a mechanic 38 working on the roof 62 to conveniently control the safety controller 30 by operating the remote control 36. It in particular allows the mechanic to switch between the different safety modes of the safety controller 30 in order to adjust the safety mode of the safety controller 30 to the maintenance and/or repair work to be executed by the mechanic 38.

Operating the remote control 36 may be possible only after a service tool and/or a mechanical or electronic key (not shown) has been introduced or presented in order to prevent an unauthorized operation of the safety controller 30. The service tool or the electronic key may be provided as a dongle and/or as a key provided on a mobile phone.

FIG. 8 depicts a control panel 45a of a remote control 36 according to an exemplary embodiment.

The control panel 45a comprises a plurality of push buttons 46-50, including push buttons 47, 48 for manually moving the elevator car 60 upwards and downwards, respectively; a push button 49 for establishing vocal communication, e.g. with a person within the interior of the elevator car 60, the machine room 40 and/or with a remote service center (not shown in the figures); and a stop button 46 for immediately stopping any movement of the elevator car 60.

The push buttons 46-50 further include an alarm button 50 for triggering an alarm in an emergency situation, and two inspection switches 51, 52. In the embodiment depicted in FIG. 8, the inspection switches 51, 52 are rotational switches.

A first inspection switch 51 allows switching between a normal operation mode, i.e. a mode for transporting passengers and/or cargo between the landings 8a, 8b, 8c, and an inspection mode. The second inspection switch 52 allows selecting one of a plurality of different inspections modes, in particular including at least some of the modes discussed before.

The control panel 45a also comprises an optional socket 53 configured for connecting a service key and/or dongle (not shown) with the remote control 36.

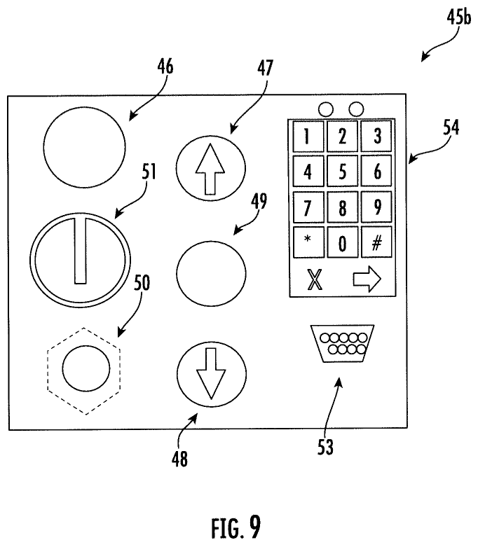

FIG. 9 depicts a control panel 45b of a remote control 36 according to another exemplary embodiment.

The control panel 45b also comprises a plurality of push buttons 46-50, including push buttons 47, 48 for manually moving the elevator car 60 upwards and downwards, respectively; a push button 49 for establishing vocal communication, e.g. with a person within the interior of the elevator car 60, the machine room 40 and/or with a remote service center (not shown in the figures); and a stop button 46 for immediately stopping any movement of the elevator car 60.

The push buttons 46-50 further include an alarm button 50 for triggering an alarm in an emergency situation, and a single inspection switch 51. In the embodiment depicted in FIG. 9, the inspection switch 51 is a rotational switch.

The inspection switch 51 allows switching between a normal operation mode, i.e. a mode for transporting passengers and/or cargo between the landings 8a, 8b, 8c, and an inspection mode. The control panel 45a also comprises an optional socket 53 which is configured for connecting a service key and/or dongle (not shown) with the remote control.

The control panel 45b additionally comprises a keypad or keyboard 54 which allows entering alphanumerical information.

The keypad or keyboard 54 in particular may be used for entering a numerical or alphanumerical code (passcode) for unlocking the remote control 36.

The remote control 36 further allows selecting one of a plurality of inspection modes, in particular one of the modes discussed before, by entering a selection code identifying the respective mode via the keypad or keyboard 54.

The skilled person understands that the spatial arrangement of the elements on the control panels 45a, 45b depicted in FIGS. 8 and 9 is only exemplary and that these elements may be arranged differently, if appropriate.

The remote control 36 described herein is considered as new and inventive by itself, in particular irrespective of providing a bidirectional safety gear and/or a safety controller as referred to in independent claim 1. Applicant therefore reserves the right to draft an independent claim related to the remote control 36 on its own.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 elevator drive
8a, 8b, 8c landing
9 lintel
10 sill
11 landing door
12 elevator car door
14 car guide member
15 counterweight guide member
16 counterweight
17 coded tape
18 car position sensor
19 elevator controller
20 (bidirectional) safety gear
20a, 20b safety mechanism
22, 22a, 22b engagement mechanism
23, 23a, 23b engagement element
24, 24a, 24b actuator
26 pit
28 buffer
30 safety controller
32 upper end of the hoistway
33 lower end of the hoistway
34 speed sensor
38 mechanic
40 machine room
42 component of the elevator system
44 component of the elevator system
46-50 push buttons
51 (first) inspection switch
52 second inspection switch
53 socket
54 keypad/keyboard
60 elevator car
62 roof
64 floor
66 car side wall
68 interior space of the elevator car
70 passenger
71 landing control panel
72 elevator car control panel
D minimum distance of the upper positional limit from the upper end of the hoistway
D′ minimum distance of the lower positional limit from the lower end of the hoistway
d minimum distance of the bottom of the elevator car from the lower end of the hoistway
h height of the elevator car
L lower positional limit
U upper positional limit

What is claimed is:

1. An elevator system (2) comprising:
a hoistway (4) extending between a plurality of landings (8a, 8b, 8c);
an elevator car (60) configured for moving in two opposite directions along the hoistway (4); and
an elevator safety system comprising:
a bidirectional safety gear (20) configured for stopping, upon activation, any movement of the elevator car (60) traveling in any of the two opposite directions; and
a safety controller (30) configured for activating the bidirectional safety gear (20) when a predefined safety condition is met;
wherein the safety controller (30) is switchable between a plurality of different safety modes, each safety mode setting at least one predefined safety condition.

2. The elevator system (2) according to claim 1, further comprising a car position sensor (18) configured for detecting the absolute position of the elevator car (60) within the hoistway (4),
wherein the plurality of safety modes comprise at least one safety mode setting at least one predefined upper positional limit (U) and/or at least one predefined lower positional limit (L); and
wherein the safety controller (30) is configured for activating the bidirectional safety gear (20) when the absolute position of the elevator car (60) exceeds the predefined upper positional limit (U) and/or when the absolute position of the elevator car (60) falls below the predefined lower positional limit (L).

3. The elevator system (2) according to claim 2, wherein the plurality of safety modes comprise at least one below the car inspection mode setting only a lower positional limit (L), and/or wherein the plurality of safety modes comprise at least one top of car inspection mode setting only an upper positional limit (U).

4. The elevator system (2) according to claim 1, wherein the plurality of safety modes comprise at least one safety mode setting an upper positional limit (U) and a lower positional limit (L).

5. The elevator system (2) according to claim 1, wherein the safety controller (30) is configured for determining the moving speed of the elevator car (60) and activating the bidirectional safety gear (20) when the moving speed of the elevator car (60) exceeds a predetermined moving speed limit, and wherein the predetermined moving speed limit is set as a function of the currently selected safety mode and/or as a function of the current position of the elevator car (60) within the hoistway (4).

6. The elevator system (2) according to claim 5, wherein the safety controller (30) is configured for determining the moving speed of the elevator car (60) from absolute positions of the elevator car (60) detected by the car position sensor (18).

7. The elevator system (2) according to claim 5, further comprising a speed sensor (34) configured for detecting the moving speed of the elevator car (60).

8. The elevator system (2) according to claim 1, wherein the safety modes include at least one maintenance mode in which the moving speed of the elevator car (60) is reduced compared to normal operation.

9. The elevator system (2) according to claim 1, wherein the bidirectional safety gear (20) includes at least one bidirectionally acting safety mechanism, which is configured for braking the movement of the elevator car (60) in opposite directions, or a combination of at least two unidirectionally acting safety mechanisms (20a, 20b), wherein each safety actuator is configured for braking the movement of the elevator car (60) in one direction, respectively.

10. The elevator system (2) according to claim 1, wherein the bidirectional safety gear (20) includes at least one bidirectional safety actuator (24) configured for actuating at least two engagement members (23a, 23b) which are configured for braking the movement of the elevator car (60) in either of the two opposite directions.

11. The elevator system (2) according to claim 1, wherein the bidirectional safety gear (20) includes a combination of at least two unidirectional safety actuators (24a, 24b), wherein each safety actuator (24a, 24b) is configured for actuating at least one engagement member (23a, 23b) configured for braking the movement of the elevator car (60) when traveling in one direction, respectively.

12. The elevator system (2) according to claim 1, wherein the safety modes include at least one safety mode in which the bidirectional safety gear (20) is activated only after the movement of the elevator car (60) has been stopped.

13. The elevator system (2) according to claim 1, wherein the safety modes include at least one safety mode in which the bidirectional safety gear (20) is activated while the elevator car (60) is still moving.

14. The elevator system (2) according to claim 1, wherein the safety modes include at least one safety mode in which the elevator car (60) is moved to a predetermined position with respect to a landing (8a, 8b, 8c); in particular with respect to a sill (10) or a lintel (9) of a landing door (11).

15. A method of operating an elevator system (2) according to claim 1, wherein the method includes switching the safety controller (30) to one of the plurality of different safety modes.
